(19) United States
(12) Patent Application Publication
(10) Pub. No.: US 2025/0347536 A1
(43) Pub. Date: Nov. 13, 2025

(54) GEOREFERENCING AND INTEGRATION OF FIBER OPTICS WITH PIPELINE PIGGING INSPECTIONS

(71) Applicant: Cameron International Corporation, Houston, TX (US)

(72) Inventors: Kang Wang, Houston, TX (US); Josh May, Hockley, TX (US); Adnan Chughtai, Houston, TX (US); Judy Dong, Richmond, TX (US); Yifei Wu, Missouri City, TX (US)

(21) Appl. No.: 19/177,966

(22) Filed: Apr. 14, 2025

Related U.S. Application Data
(60) Provisional application No. 63/645,671, filed on May 10, 2024.

(51) Int. Cl. G01D 5/26; G06T 3/40; G06T 7/00; G06T 7/11; G06T 7/20; G06T 11/20; G06T 11/60

(52) U.S. Cl. CPC G01D 5/268; G06T 3/40; G06T 7/0002; G06T 7/11; G06T 7/20; G06T 11/206; G06T 11/60; G06T 2200/24; G06T 2207/20021; G06T 2207/20081; G06T 2207/30241

(57) ABSTRACT

A method may include receiving first data collected as a first pipeline inspection gauge (PIG) passes through a first pipeline and training a machine learning model using the first data. The method may further include receiving second data collected via an optical fiber as a second PIG passes through a second pipeline, wherein the second data is representative of one or more fiber optic events and applying the trained machine learning model to the second data. Additionally, the method may include identifying a position of the second PIG and generating a graphical user interface (GUI) to display the position of the second PIG.

### CROSS-REFERENCE TO RELATED APPLICATION

This application claims priority to and the benefit of U.S. Provisional Patent Application No. 63/645,671, entitled “GEOREFERENCING AND INTEGRATION OF FIBER OPTICS WITH PIPELINE PIGGING INSPECTIONS,” filed on May 10, 2024, which is hereby incorporated by reference in its entirety for all purposes.

### BACKGROUND

The present disclosure generally relates to georeferencing and integration of fiber optics with pipeline pigging inspections. More specifically, the present disclosure relates to a realtime pipeline inspection gauge (PIG) tracking algorithm using machine learning/pattern recognition.

Oil and gas pipeline networks are generally considered the most economical and safest means of transporting crude oil with high efficiency and reliability. Fiber optics may be an isolated system and fiber route geo-referencing may be completed using field teams that perform manual activities at discrete points along a pipeline (e.g., every 2 kilometers). This may be inefficient and may not have a high accuracy. Accordingly, new methods for pipeline tracking may be desirable.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In some configurations, a method may include monitoring pipeline inspection gauge (PIG) runs along a pipeline using an optical fiber to detect fiber optic events. The method may include training a machine learning model prior to monitoring the PIG runs. In addition, the method may include automatically calibrating distance along the optical fiber to distance along the pipeline. Furthermore, the method may include contextualizing the fiber optic events with, for example, an inspection report, a simulation, a supervisory control and data acquisition (SCADA) system, and/or a historical report.

In certain embodiments, a method may include receiving first data collected as a first pipeline inspection gauge (PIG) passes through a first pipeline and training a machine learning model using the first data. The method may also include receiving second data collected via an optical fiber as a second PIG passes through a second pipeline, wherein the second data is representative of one or more fiber optic events and applying the trained machine learning model to the second data. Furthermore, the method may include identifying a position of the second PIG and generating a graphical user interface (GUI) to display the position of the second PIG.

In certain embodiments, a system may include processing circuitry, a memory, accessible by the processing circuitry, and storing instructions that, when executed by the processing circuitry, cause the processing circuitry to perform operations including receiving first data collected as a first pipeline inspection gauge (PIG) passes through a first pipeline and training a machine learning model using the first data. The operations may further include receiving second data collected via an optical fiber as a second PIG passes through a second pipeline, wherein the second data is representative of one or more fiber optic events and applying the trained machine learning model to the second data. In addition, the operations may include identifying a position of the second PIG, generating a graphical user interface (GUI) to display the position of the second PIG, and automatically calibrating a distance along the optical fiber to distance along the second pipeline.

In certain embodiments, a non-transitory, computer readable medium including instructions that, when executed by a processing circuitry, may cause the processing circuitry to perform operations including receiving first data collected as a first pipeline inspection gauge (PIG) passes through a first pipeline and training a machine learning model using the first data. The operations may further include receiving second data collected via an optical fiber as a second PIG passes through a second pipeline, wherein the second data is representative of one or more fiber optic events and applying the trained machine learning model to the second data. Furthermore, the operations may include identifying a position of the second PIG, generating a graphical user interface (GUI) to display the position of the second PIG, automatically calibrating a distance along the optical fiber to distance along the second pipeline, and overlaying the second data with the GUI.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an example of a monitoring system and waterfall plots of data collected at three different time windows, according to an embodiment of the present disclosure;

FIG. 2 is a flowchart of a workflow for an offline training phase, according to an embodiment of the present disclosure;

FIG. 3 is a plot of an example of a training image for a machine learning (ML) training/validation model, according to an embodiment of the present disclosure;

FIG. 4 is a flowchart of a workflow for a real-time detection phase, according to an embodiment of the present disclosure;

FIG. 5 is a graph of an example of a result of a pipeline inspection gauge (PIG) tracking algorithm, according to an embodiment of the present disclosure;

FIG. 6 is a block diagram of an example of a system displaying non-correlation of an optical distance along a fiber to a physical distance of a pipeline, according to an embodiment of the present disclosure;

FIG. 7 is a flowchart of a workflow for a semiautomatic calibration, according to an embodiment of the present disclosure; and

FIG. 8 is a graph of an example of a graphical user interface (GUI) contextualizing fiber optic events together with an inspection report and other sources of results, according to an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

As the oil and gas pipeline industry shifts toward digitalization, machine learning (ML) and artificial intelligence (AI) play an increasingly important role in asset integrity management, including, for example, operation monitoring, leak and intrusion detection, corrosion protection, and flow assurance. The present disclosure provides an integrated asset integrity management approach utilizing fiber optic and pipeline pigging inspection reports, with the aid of pattern recognition or machine learning, to generate unique pipeline integrity insights.

Fiber-optic distributed acoustic sensing (DAS) technologies may be routinely used to monitor pipeline activities. Critical events such as leaking, digging, and pigging may be captured by quantitatively analyzing often-repeating signatures on the fiber-optic-generated space-time image. This may be treated as a pattern recognition or machine learning problem. Specifically for a pigging operation, a pipeline inspection gauge (PIG) may continuously generate signatures of V-shapes on the DAS image whenever it passes a weld joint. A state-of-the-art fast object detection algorithm (e.g., YOLO) may be used to perform accurate PIG tracking and other activities. Further, using AI, routine inspection reports may be automatically calibrated, cross-validated and then contextualized together with the fiber events. The presented event detection and classification algorithm may achieve high location accuracy, superior to current industry-standard methods. For pigging activities, it may accurately identify the entire PIG trajectory.

The present disclosure presents novel use of fast machine learning models to accurately detect and track pipeline activities. Additionally, these detections may be later automatically calibrated with inspection reports for cross-validation of different monitoring technologies under a single integrated pipeline integrity management platform, providing operators with unique insights.

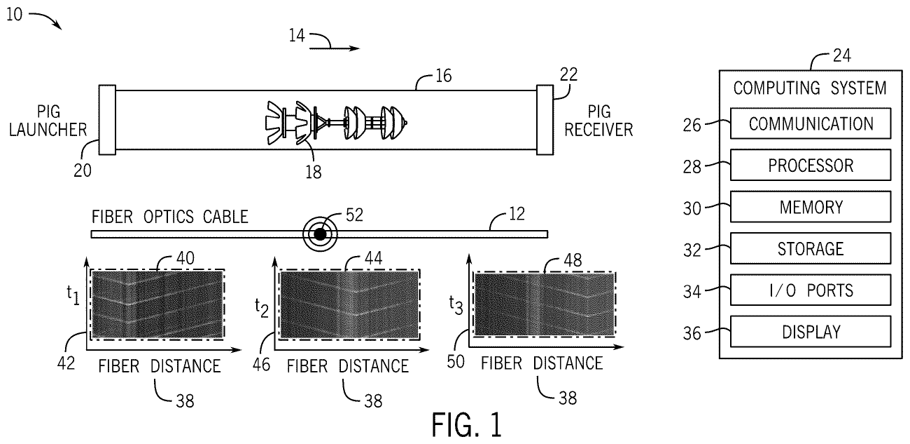

With the foregoing in mind, FIG. 1 is a schematic view of a monitoring system 10. As illustrated, one or more fiber optics cables 12 (e.g., optical fiber) may be installed along an axial direction 14 (e.g., along an exterior) of a pipeline 16. A pipeline inspection gauge (PIG) 18 may be equipped with sensors and travel along the pipeline 16 for a specified period of time (e.g., a few hours, a few days, etc.) during a pigging operation. The PIG 18 may travel from a PIG launcher location 20 (e.g., starting location) to a PIG receiver location 22 (e.g., ending location). The PIG 18 may be retrieved after an inspection job is complete. Upon retrieval, an inspection report may be generated that may include time, GPS, distance along the pipeline 16, and certain events or features identified during the specified period of time (e.g., deformation, cracking, metal loss, corrosion, etc.).

The monitoring system 10 may include a computing system 24. The computing system 24 may include any suitable computing device, cloud-computing device, or the like and may include various components to perform various analysis operations related to performing the embodiments described herein. By way of example, the computing system 24 may include a communication component 26, a processor 28 (e.g., processing circuitry), a memory 30, a storage component 32, input/output (I/O) ports 34, a display 36, and the like. The communication component 26 may be a wireless or wired communication component that may facilitate communication between different monitoring systems, gateway communication devices, various control systems, and the like. The processor 28 may be any type of computer processor (e.g., multi-core) or microprocessor capable of executing computer-executable code. The memory 30 and the storage component 32 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 28 to perform the presently disclosed techniques. The memory 30 and the storage component 32 may also be used to store data received via the I/O ports 34, data analyzed by the processor 28, or the like.

The I/O ports 34 may be interfaces that may be coupled to various types of I/O modules such as sensors, programmable logic controllers (PLC), and other types of equipment. The I/O ports 34 may also serve as an interface to enable the computing system 24 to connect and communicate with surface instrumentation, servers, computing devices, and the like. Connection between the I/O ports 34 and surface instrumentation, servers, and infrared or other equipment may be a wireless or wired communication.

The display 36 may include any type of electronic display such as a liquid crystal display, a light-emitting-diode display, and the like. As such, data acquired via the I/O ports and/or data analyzed by the processor 28 may be presented on the display 36. In certain embodiments, the display 36 may be a touch screen display or any other type of display capable of receiving inputs from an operator. Although the computing system 24 is described as including the components presented in FIG. 1, the computing system 24 should not be limited to including the components listed in FIG. 1. Indeed, the computing system 24 may include additional or fewer components than described above.

Additionally, FIG. 1 illustrates waterfall images that are plots of data collected at three-time windows corresponding to various stages of the pigging operation. The waterfall image may follow a vertical axis (e.g., y-axis) measuring time (e.g., in minute) and a horizontal axis 38 (e.g., x-axis) measuring fiber distance (e.g., in meters). A V-shape may be visible in the waterfall image when the PIG 18 passes a weld joint. In a waterfall type plot showing time on one axis and position along the fiber optic cable 12 on another axis and plotting intensity of acoustic disturbances, a pressure wave may appear as a characteristic V-shape due to the pressure waves travelling in opposite directions along the pipeline 16 at a constant speed. The V-shape may represent the acoustic signature of the weld joint and may be used to detect and locate the weld joint. A first waterfall image 40 may correspond to a starting stage of the pigging operation for a first time interval 42 (e.g., t_1). A second waterfall image 44 may correspond to a middle stage of the pigging operation for a second time interval 46 (e.g., t_2). A third waterfall image 48 may correspond to an ending stage of the pigging operation for a third time interval 50 (e.g., t_3). The V-shape seen in the first waterfall image 40, the second waterfall image 44, and the third waterfall image 48 may correspond to a weld location 52 on the fiber optic cable 12.

Basic principles may be used for interpreting the space-time waterfall image. Specifically, a horizontal line represents an instantaneous widespread disturbance, while a vertical line represents a local perturbation lasting a period of time. Furthermore, a sloped line denotes a moving object with the slope corresponding to the speed.

In various embodiments, the present disclosure may provide a real-time PIG tracking algorithm using machine learning/pattern recognition, automatic calibration between a distance along fiber and a distance along pipeline, and/or contextualizing fiber optic events together with inspection report or other source of results. The other source of results may include a simulation, a supervisory control and data acquisition (SCADA) system, and/or historical reports.

A PIG tracking algorithm used in FIG. 1 (e.g., implemented via the computing system 24) may include an offline training phase and a real-time detection phase. The offline training phase may include collecting existing PIG operation data and training a machine learning (ML) model that detects V-shapes with high confidence. In some configurations, a YOLOv7 ML object detection model may be used. In other configurations, a U-Net ML model may be used. It should be noted that any suitable ML model may be used.

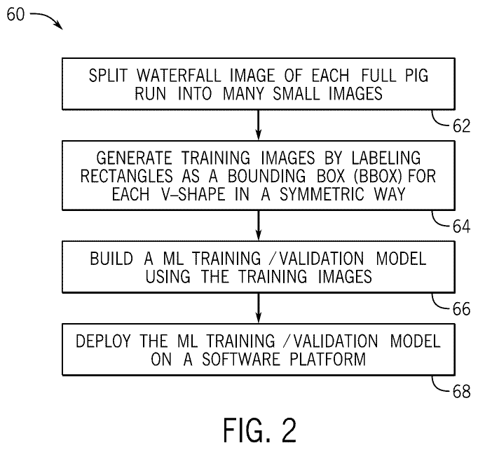

FIG. 2 is a flowchart of a workflow 60 for the offline training phase. Although the following description of the workflow 60 is described in a particular order, which represents a particular embodiment, it should be noted that the workflow 60 may be performed in any suitable order. Moreover, it should be noted that the workflow 60 may be performed by any suitable computing device (e.g., the computing system 24) or combination of computing devices, associated with a respective pipeline.

At block 62, the workflow 60 may split the waterfall image of each full PIG run into many small images (e.g., the first waterfall image, the second waterfall image, the third waterfall image). Each image may contain a time interval (e.g., 1 minute, the first time interval 42, the second time interval 46, the third time interval 50) of data. For example, a PIG run of 5 hours may be split into 300 images.

At block 64, the workflow 60 may generate training images by labeling rectangles as a bounding box (bbox) for each V-shape in a symmetric way. Therefore, an upper left corner and an upper right corner of the bbox may lie on the V-shape, while a bottom center point of the bbox may lie on the PIG location (e.g., weld location 52). A width of the bbox may be altered to create a consistent labeling strategy, which may ensure high detection accuracy.

At block 66, the workflow 60 may build a ML training/validation model (e.g., a prediction model) using the training images. The workflow 60 may refer to ML model documentation (e.g., the inspection report). For example, the ML training/validation model may be YOLOv7, an object detection model. YOLOv7 is a real-time object detector with a high accuracy among known real-time object detectors. YOLOv7 may be trained on an MS COCO dataset from scratch without using any other datasets or pre-trained weights. Other ML training/validation models may also be used such as U-Net. U-Net is a convolutional network architecture for fast and precise segmentation of images. If the ML training/validation model has a fast frame per second rate, then the ML training/validation model may be able to detect signatures in real time. For example, the ML training/validation model may use 20,000 training images. Once the ML training/validation model is trained using training images, parameter files may be used to predict future images.

At block 68, the workflow 60 may deploy the ML training/validation model (e.g., the prediction model) on a software platform. The ML training/validation model may be used for real-time PIG tracking to detect V-shapes with high confidence.

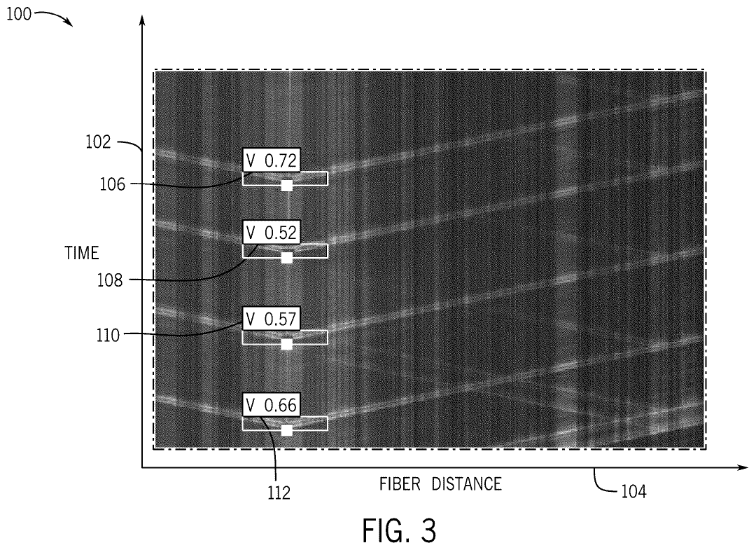

With the foregoing in mind, FIG. 3 is a plot of a training image 100 for the ML training/validation model (e.g., the prediction model). The plot may follow a vertical axis 102 (e.g., y-axis) measuring time (e.g., in minute) and a horizontal axis 104 (e.g., x-axis) measuring fiber distance (e.g., in meters).

The training image 100 (e.g., an example detected image) may include a first bbox 106, a second bbox 108, a third bbox 110, and a fourth bbox 112 as described in block 64 of FIG. 2. In addition, each bbox may include a number corresponding to a confidence level of the detection. The illustrated embodiment may be an example of the training image generated in block 64 of FIG. 2.

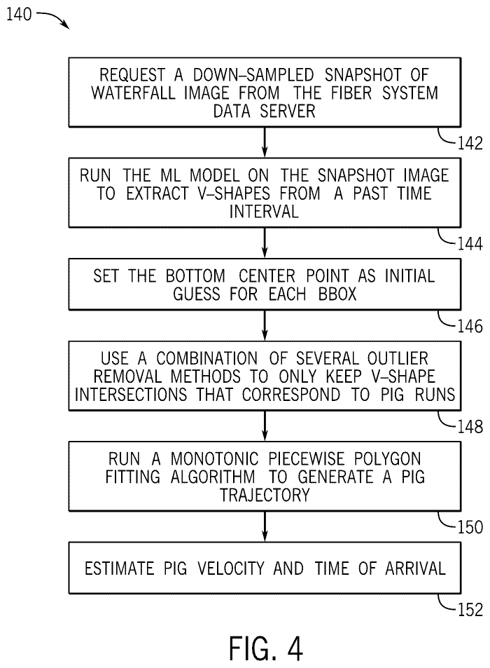

FIG. 4 is a flowchart of a workflow 140 for the real-time detection phase. Although the following description of the workflow 140 is described in a particular order, which represents a particular embodiment, it should be noted that the workflow 140 may be performed in any suitable order. Moreover, it should be noted that the workflow 140 may be performed by any suitable computing device (e.g., the computing system 24) or combination of computing devices, associated with a respective pipeline.

At block 142, the workflow 140 may request a down-sampled snapshot of the waterfall image from a fiber system data server at every time interval (e.g., 1 minute) as PIG runs are monitored. The fiber system data server may capture a space-time image during the PIG run. The space-time image may be very large in size, with high resolution on both time and distance. The down-sampled snapshot of the waterfall image may be a smaller, lower-resolution version of the waterfall image, which may be created by reducing a number of pixels while preserving overall content of the waterfall image.

At block 144, the workflow 140 may run the ML training/validation model on the down-sampled snapshot image to extract V-shapes from a past time interval. The ML training/validation model may analyze the down-sampled snapshot image for patterns learned from the training images in the offline training phase. After identifying patterns in the down-sampled snapshot image, the ML training/validation model may extract any data expected to correspond to V-shapes from the down-sampled snapshot image. For example, the ML training/validation model may extract multiple V-shapes corresponding to each well location (e.g., weld location 52)

At block 146, the workflow 140 may set the bottom center point (e.g., lower midpoint) as an initial guess for each bbox. The bottom center point may lie on the PIG location (e.g., weld location 52) as identified during the offline training phase. A minor adjustment of pixel may be used as an intersection of two line segments whose slopes are close to speed of sound.

At block 148, the workflow 140 may use a combination of several outlier removal methods (e.g., filter by confidence level, clustering, derivative control) to only keep V-shape intersections and/or detected events that correspond to PIG runs. Each detected object may have a confidence level of 0 to 1 fraction, therefore if multiple bboxes are detected at very close locations, the workflow 140 may keep the bbox with a higher confidence. The PIG may create continuous signals whenever it hits a weld joint, using clustering methods to filter out isolated V-shapes, which may not necessarily be generated by the PIG, but rather another disturbance. The traveling speed of the PIG has upper/lower limits, such that the slope between signals can be analyzed to filter out unlikely PIG locations.

At block 150, the workflow 140 may run a monotonic piecewise polygon fitting algorithm to generate a PIG trajectory. The monotonic piecewise polygon fitting algorithm may be an algorithm used to find a best-fitting monotonic piecewise polygon to approximate a set of points or a curve. The monotonic piecewise polygon fitting algorithm may either always increase or may always decrease and lie as close to the set of points or the curve as possible. Further, the monotonic piecewise polygon fitting algorithm may involve minimizing a distance between the best-fitting monotonic piecewise polygon and given data, using methods such as least-squares fitting or optimization techniques. The best-fitting monotonic piecewise polygon may be a function defined by different formulas or rules over different intervals of a domain, with each interval's boundary forming a piece of a graph of an overall function, often resembling a polygon (e.g., a plane figure with at least three straight sides and angles). For example, the monotonic piecewise polygon fitting algorithm may use the V-shape intersections to generate the PIG trajectory. The monotonic piecewise polygon fitting algorithm may approximate the PIG trajectory using the V-shape intersections as the set of points and finding the best-fitting monotonic piecewise polygon.

At block 152, the workflow 140 may estimate a PIG velocity and estimate a time of arrival (ETA). The estimate may be determined using a slope of a trajectory over a certain time range (e.g., 1 min) combined with an image pixel size definition.

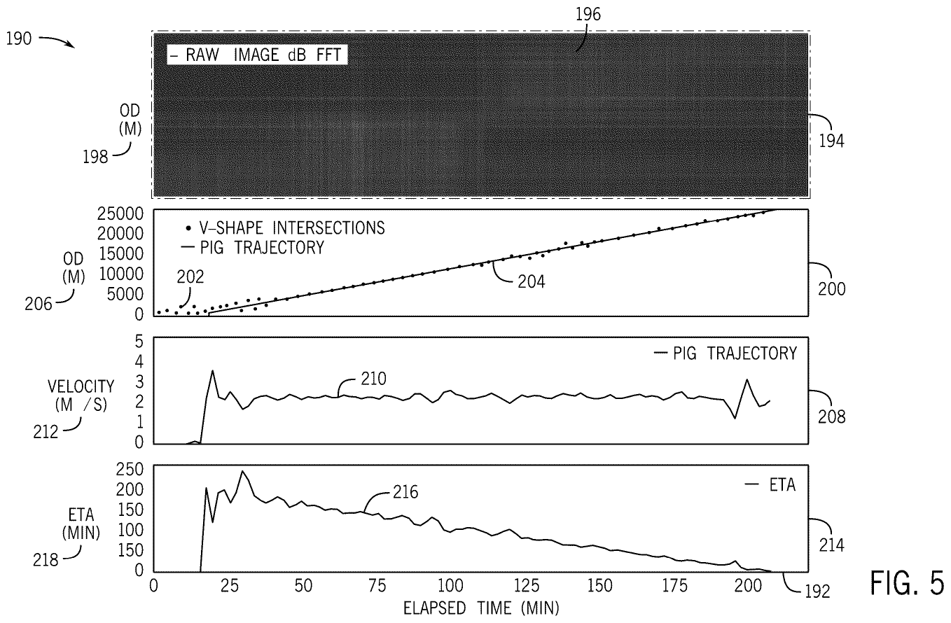

With the foregoing in mind, FIG. 5 is a graph of a result 190 of the PIG tracking algorithm. The result may include four stacks. Each stack may have a horizontal axis 192 (e.g., x-axis) representing elapsed time (e.g., in minutes). The elapsed time may cover a duration of the pigging operation.

A first stack 194 may show the waterfall image over the duration of the pigging operation. The first stack may have a vertical axis 198 (e.g., y-axis) representing optical distance (OD) (e.g., in meters).

A second stack 200 may show the extracted V-shape intersection points 202 and a fitted trajectory 204 (e.g., PIG trajectory). The second stack may have a vertical axis 206 (e.g., y-axis) representing OD (e.g., in meters). The fitted trajectory 204 (e.g., PIG trajectory) may be approximated using the monotonic piecewise polygon fitting algorithm described above.

A third stack 208 may show the estimated PIG velocity 210 averaged in intervals (e.g., 1 minute). The third stack may have a vertical axis 212 (e.g., y-axis) representing velocity (e.g., in meters/seconds).

The fourth stack 214 may show the ETA 216 computed by dividing a remaining distance by an estimated speed. The fourth stack may have a vertical axis 218 (e.g., y-axis) representing ETA (e.g., in minutes).

It should be noted that the speed and distance illustrated correspond to the optical distance (OD) along the fiber, which is not necessarily the same as pipeline distance (PD) along a pipeline (e.g., the pipeline 16). In fact, the optical distance along a fiber (e.g., the fiber optics cable 12) frequently bears little relation to the physical distance of the pipeline (e.g., the pipeline 16) due to various factors including a refractive index of the fiber (e.g., the fiber optics cable 12), physical cable loops (e.g., fiber loops), and so forth.

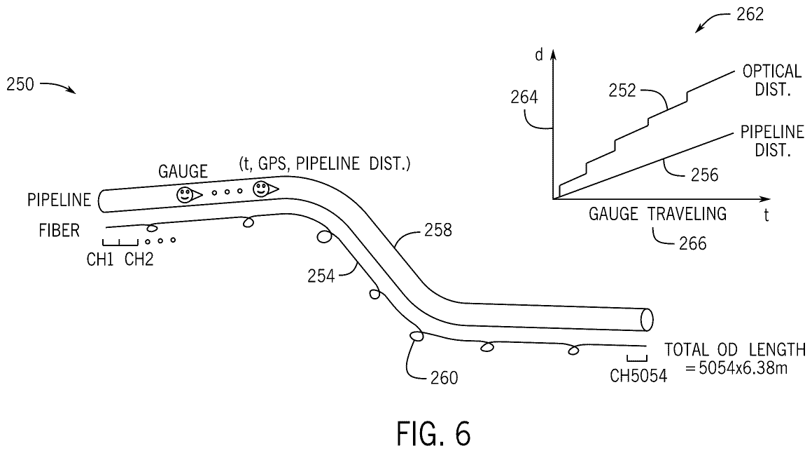

FIG. 6 is a block diagram of a system 250 displaying non-correlation of an optical distance 252 along a fiber 254 to a physical distance (e.g., a pipeline distance 256) of a pipeline 258 highlighting diversion between pipeline distance and optical distance. The optical distance 252 may be larger than the pipeline distance 256 due to physical cable loops 260 (e.g., fiber loops), as well as other factors. Correspondingly, in some embodiments, the cable may be laid along the inside of the pipeline as the pipeline curves, resulting in the optical distance being less than the pipeline distance.

A plot 262 may show the non-correlation between the optical distance 252 and the pipeline distance 256. The plot 262 may follow a vertical axis 264 (e.g., y-axis) measuring distance (d) (e.g., in meters) and a horizontal axis 266 (e.g., x-axis) measuring gauge traveling time (t) (e.g., in minutes). The plot 262 may show the optical distance 252 and the pipeline distance 256.

The calibration may be completed by comparing the fiber optics (FO) detected pigging trajectory with the inspection report. This comparison may enable accurate coordinates for any event identified on the fiber image to be obtained. Systems and methods of the present disclosure may advantageously automate this calibration by taking advantage of pigging inspection reports

Therefore, a high-accuracy distance calibration may be performed to associate optical distances with a physical latitude and longitude. Then, calculations described above may be rerun to obtain more accurate results.

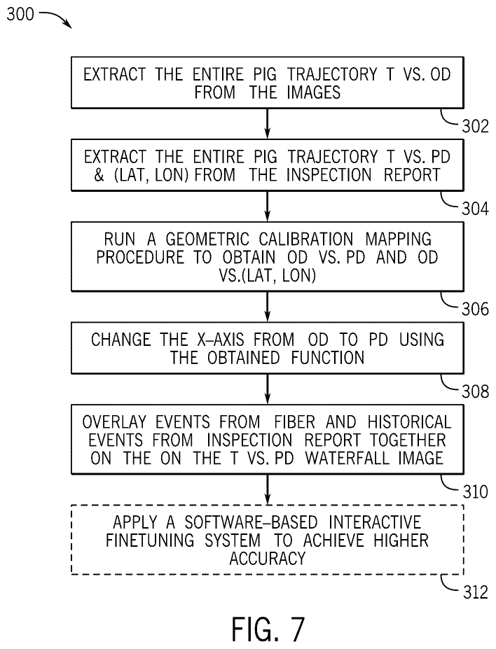

FIG. 7 is a flowchart of a workflow 300 for a semiautomatic calibration. Although the following description of the workflow 300 is described in a particular order, which represents a particular embodiment, it should be noted that the workflow 300 may be performed in any suitable order. Moreover, it should be noted that the workflow 300 may be performed by any suitable computing device (e.g., the computing system 24) or combination of computing devices, associated with a respective pipeline.

Although the workflow 60 of FIG. 2 (e.g., block 64, block 66, and block 68) and the workflow 140 of FIG. 4 (e.g., block 142, block 144, and block 146) focus on the V-shape signatures detected using an object detection algorithm, the workflow 300 of FIG. 7, as well as other workflows described herein, may also be applicable to cases where other event detection methods (e.g. using other image processing techniques or ML methods) are used to detect the pigging events and locations. The semiautomatic calibration workflow may be done after completion of the pigging operation. It may only be performed once for each pipeline segment. The semiautomatic calibration workflow may give an accurate function of PD=f(OD), therefore, coordinate=f(OD) for each pixel along the horizontal axis of the waterfall image.

At block 302, the workflow 300 may extract the entire PIG trajectory (e.g., t versus OD) from the images. The PIG trajectory may be generated using the monotonic piecewise polygon fitting algorithm and the V-shape intersections. The monotonic piecewise polygon fitting algorithm may be used to find a best-fitting monotonic piecewise polygon to approximate the entire PIG trajectory based on the V-shape intersections extracted from the images.

At block 304, the workflow 300 may extract the entire PIG trajectory (e.g., t versus PD) and latitude and longitude (e.g., lat, lon) from the inspection report. In some embodiments, the inspection report may be in a csv format.

At block 306, the workflow 300 may run a geometric calibration mapping procedure to obtain optical distance versus pipeline distance (e.g., OD versus PD). The geometric calibration mapping procedure may establish a relationship between three-dimensional world points (e.g., the optical distance of the fiber optics cable 12) and two-dimensional image projections (e.g., the pipeline distance of the pipeline 16) using time versus optical distance from block 302 and time versus pipeline distance from block 304. For example, the geometric calibration mapping procedure may map three-dimensional points in the real world to their corresponding two-dimensional coordinates in an image, enabling tasks such as 3D reconstruction and object tracking. While establishing the relationship, the geometric calibration mapping procedure may also determine the latitude and longitude of the pipeline distance. Therefore, the workflow 300 may also obtain optical distance versus latitude and longitude (e.g., OD versus (lat, lon)).

At block 308, the workflow 300 may change the horizontal axis from OD to PD using the obtained function to cross-validate fiber data and inspection report in the software system. Changing the horizontal axis may make the image width shorter because jumping points (e.g., fiber loops) may be identified and removed.

At block 310, the workflow 300 may overlay various events from the fiber and historical events from the inspection report and other data together on the time versus pipeline distance (e.g., t versus PD) waterfall image. The overlaid events on the time versus pipeline distance waterfall image may highlight locations in the pipeline where a possible issue may occur. The overlay may provide cross-validated integrity insights by putting multiple sources of information together an event detection confidence may improve. For example, when multiple sources of information point to an event at a same time and location, then the event detection confidence may be higher.

At block 312, the workflow 300 may apply a software-based interactive fine-tuning to achieve even higher accuracy. The software-based interactive fine-tuning may be an optional user-software interaction step to be able to fix any issue that the semiautomatic calibration may cause. A GUI may allow the operator to manually refine and/or correct the semiautomatic calibration to further improve the accuracy.

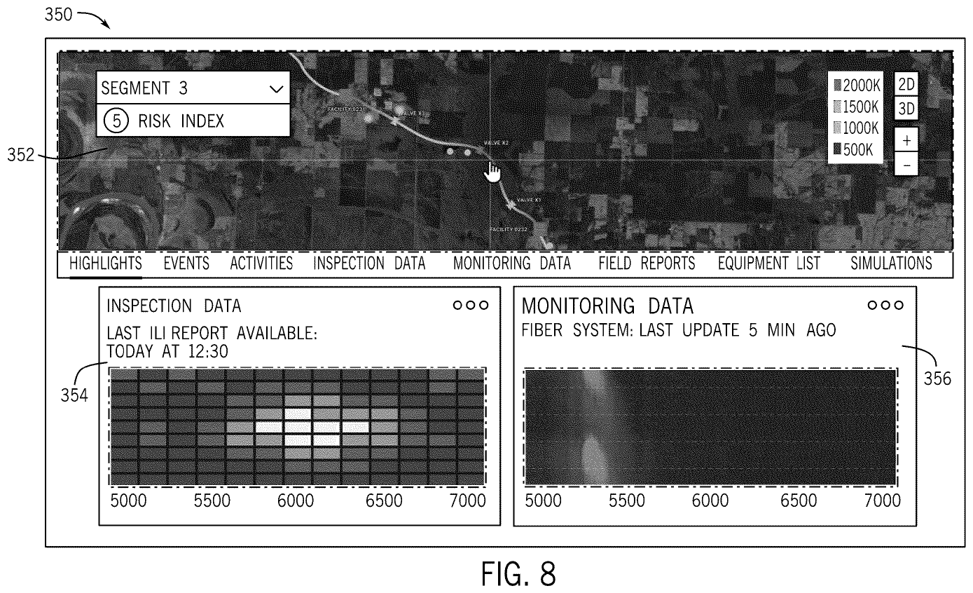

With the foregoing in mind, FIG. 8 is a graph of a graphical user interface (GUI) 350 contextualizing fiber optic events in a geospatial plot 352 with inspection data 354 and monitoring data 356. For example, the GUI 350 may accurately mark fiber events on the geospatial plot 352. In addition, the GUI 350 may allow for inspection data 354 (e.g., historical inspection report data) and monitoring data 356 (e.g., historical fiber monitoring statistics data) to be viewed side by side to identify regions of high risk indicated by both sources of information. In systems and methods according to the present disclosure, machine learning assisted cross-validation of different monitoring technologies may allow for contextualizing events under a single integrated pipeline integrity management platform, thereby revealing unique insights not previously seen using AI.

For example, the plot 352 may highlight a segment (e.g., segment 3) of the trajectory of the PIG 18. In the illustrated embodiment, segment 3 is selected which is shown from the distance from point A (e.g., Facility 0231) to point B (Facility 0232). In this example, there are three valves (e.g., valve x1, valve x2, valve x3) in segment 3. It is important to note that other segments may be shorter or longer and may include more or less valves.

Along the pipeline within the selected segment 3, the pipeline may be color coded following a color scale. The color scale may correspond to the number of events found on that particular location and/or segment. In the illustrated embodiment, a risk index corresponding to segment 3 is listed as 5. The risk index may be a normalized number between 0 and 100 and may indicate a severity of risk associated with a particular segment (e.g., segment 3) of a pipeline. Therefore, segment 3 may be a low-risk segment.

Below the plot 352, the GUI 350 may include one or more tabs representing different information. In the illustrated embodiment, the tabs include “highlights”, “events”, “activities”, “inspection data”, “monitoring data”, “field reports”, “equipment list”, and “simulations”.

In the illustrated embodiment, the GUI 350 is selected on the “highlights” tab. The “highlights” tab shows the inspection data 354 and the monitoring data 356. The inspection data 354 and the monitoring data 356 may include an indication of a time associated with received information. In the illustrated embodiment, the inspection data 354 indicates “Last ILI report available: Today at 12:30” and the monitoring data 356 indicates “Fiber System: last update 5 min ago.” Furthermore, the inspection data 354 includes a plot of boxes from 5000 to 7000 corresponding to segment 3 shown in the plot 352. The boxes are color coded in a black to white scale indicating where risk may be expected. The monitoring data 356 includes a different plot from 5000 to 7000 corresponding to segment 3 shown in the plot 352 indicating areas of concern.

The “events” tabs may include a report of all critical events such as leaking, digging, and pigging events. In addition, the “events” tab may include information about detected events and any identified fiber optic events. A historical report may also be included in this tab.

The “activities” tab may include any recorded activities including any scheduled maintenance or other in disruptions in the pipeline. The activities may include any component of the pipeline, not limited to the selected segment.

The “inspection data” tab may include information from inspection reports conducted on the pipeline. This may include inspection reports from previous years to compare how a pipeline ages over time. Furthermore, this may include a more in-depth view of the inspection data 354 shown in the “highlights” tab.

The “monitoring data” tab may include information from a supervisory control and data acquisition (SCADA) system. This may include a more in-depth view of the monitoring data 356 shown in the “highlights” tab.

The “field reports” tab may include information reported from visits to the pipeline indicating any important information. This may include notes of any areas in need of repair, or any damage identified by a worker.

The “equipment list” tab may include a complete list of equipment in the pipeline as well as equipment used for various repairs and cleaning processes. The equipment may also include reports of replaced equipment pieces indicting a location of repair and date of repair.

The “simulations” tab may include information from simulations run on the pipeline. The simulations may be able to predict areas in need of repairs in the future.

In the illustrated embodiment, fiber events may be marked on the geospatial plot. In addition, historical inspection report data and historical fiber monitoring statistics data may be viewed side by side to identify regions of high risk indicated by both sources of information.

This use case is no longer limited to pigging activities, but rather any historic inspection information or event detection. Systems and methods according to the present disclosure advantageously may allow for identifying historic deformation, cracking, metal loss, or corrosion information in the exact location on a fiber image (e.g., marked as a vertical line on the waterfall image) and determine if a matching signature on the image is present. Furthermore, the systems and methods according to the present disclosure may allow for features (e.g., weld, valve, meter, road crossing, etc.) to be directly overlayed with a fiber image. In addition, the systems and methods according to the present disclosure may allow for fiber events (e.g., leaking, pigging, digging, etc.) to be located on a live geospatial map and may be accurate within meters. The systems and methods according to the present disclosure may reveal analytics and unique insights never seen before using the integrated pipeline integrity management platform.

The subject matter described in detail above may be defined by one or more clauses, as set forth below.

A method including receiving first data collected as a first pipeline inspection gauge (PIG) passes through a first pipeline; training a machine learning model using the first data; receiving second data collected via an optical fiber as a second PIG passes through a second pipeline, wherein the second data is representative of one or more fiber optic events; applying the trained machine learning model to the second data; identifying a position of the second PIG; and generating a graphical user interface (GUI) to display the position of the second PIG.

The method of the proceeding clause, wherein the first data includes a waterfall image, and wherein training the machine learning model includes: splitting the waterfall image into a plurality of sub-images, each including a V-shaped plot; generating a plurality of respective training images based on the sub-images, wherein each training image of the plurality of respective training images includes a bounding box (bbox) centered on the V-shaped plot; and providing the training images to the machine learning model during a training cycle.

The method of any proceeding clause, wherein each of the sub-images includes a plot of the first data over a time interval.

The method of any proceeding clause, wherein first and second corners of each respective bbox intersects with the V-shaped plot, and wherein a lower midpoint of an edge of each respective bbox, opposite the first and second corners, corresponds to a location of the second PIG.

The method of any proceeding clause, wherein each bbox has a fixed width

The method of any proceeding clause, wherein training the machine learning model includes determining a respective confidence level of detection for each bbox.

The method of any proceeding clause, including requesting a down-sampled snapshot of the waterfall image from a fiber system data server; providing the down-sampled snapshot to the machine learning model to extract V-shape intersections; setting the lower midpoint of each bbox; removing outliers that are determined not to correspond to PIG runs; running a monotonic piecewise polygon fitting algorithm to generate a trajectory of the second PIG; estimating a velocity of the second PIG; and determining an estimated time of arrival (ETA) of the second PIG to a location along the second pipeline.

The method of any proceeding clause, wherein removing outliers includes using filter by confidence level, clustering, derivative control, or any combination thereof.

A system, including processing circuitry; and a memory, accessible by the processing circuitry, and storing instructions that, when executed by the processing circuitry, cause the processing circuitry to perform operations including receiving first data collected as a first pipeline inspection gauge (PIG) passes through a first pipeline; training a machine learning model using the first data; receiving second data collected via an optical fiber as a second PIG passes through a second pipeline, wherein the second data is representative of one or more fiber optic events; applying the trained machine learning model to the second data; identifying a position of the second PIG; generating a graphical user interface (GUI) to display the position of the second PIG; and automatically calibrating a distance along the optical fiber to distance along the second pipeline.

The system of the proceeding clause, wherein the first data includes a waterfall image, and wherein training the machine learning model includes: splitting the waterfall image into a plurality of sub-images, each including a V-shaped plot; generating a plurality of respective training images based on the sub-images, wherein each training image of the plurality of respective training images includes a bounding box (bbox) centered on the V-shape plot; and providing the training images to the machine learning model during a training cycle.

The system of any proceeding clause, including requesting a down-sampled snapshot of the waterfall image from a fiber system data server; providing the down-sampled snapshot to the machine learning model to extract V-shapes; setting a lower midpoint of each bbox; removing outliers that are determined not to correspond to PIG runs; running a monotonic piecewise polygon fitting algorithm to generate a trajectory of the second PIG; estimating a velocity of the second PIG; and determining an estimated time of arrival (ETA) of the second PIG to a location along the second pipeline.

The system of any proceeding clause, wherein automatically calibrating the distance along the optical fiber to distance along the second pipeline includes: extracting the trajectory of the second PIG from the waterfall image; extracting longitude and latitude of the trajectory of the second PIG from an inspection report; running a geometric calibration mapping procedure to obtain a plot of optical distance versus pipeline distance; transforming a horizontal axis of the plot from optical distance to pipeline distance using an obtained function; and overlaying one or more fiber events and one or more historical events on the plot.

The system of any proceeding clause, wherein transforming the horizontal axis of the plot reduces a width of the waterfall image.

The system of any proceeding clause, wherein automatically calibrating the distance along the optical fiber to the distance along the second pipeline includes applying a software-based interactive fine-tuning system.

The system of any proceeding clause, wherein applying the software-based interactive fine-tuning system includes examining inspection events overlayed on an image.

A non-transitory, computer readable medium including instructions that, when executed by a processing circuitry, cause the processing circuitry to perform operations including receiving first data collected as a first pipeline inspection gauge (PIG) passes through a first pipeline; training a machine learning model using the first data; receiving second data collected via an optical fiber as a second PIG passes through a second pipeline, wherein the second data is representative of one or more fiber optic events; applying the trained machine learning model to the second data; identifying a position of the second PIG; generating a graphical user interface (GUI) to display the position of the second PIG; automatically calibrating a distance along the optical fiber to distance along the second pipeline; and overlaying the second data with the GUI.

The non-transitory, computer readable medium of the proceeding clause, wherein the first data includes a waterfall image, and wherein training the machine learning model includes: splitting the waterfall image into a plurality of sub-images, each including a V-shaped plot; generating a plurality of respective training images based on the sub-images, wherein each training image of the plurality of respective training images includes a bounding box (bbox) centered on the V-shape plot; and providing the training images to the machine learning model during a training cycle.

The non-transitory, computer readable medium of any proceeding clause, including requesting a down-sampled snapshot of the waterfall image from a fiber system data server; providing the down-sampled snapshot to the machine learning model to extract V-shapes; setting a lower midpoint of each bbox; removing outliers that are determined not to correspond to PIG runs; running a monotonic piecewise polygon fitting algorithm to generate a trajectory of the second PIG; estimating a velocity of the second PIG; and determining an estimated time of arrival (ETA) of the second PIG to a location along the second pipeline.

The non-transitory, computer readable medium of any proceeding clause, wherein automatically calibrating the distance along the optical fiber to distance along the second pipeline includes: extracting the trajectory of the second PIG from the waterfall image; extracting longitude and latitude of the trajectory of the second PIG from an inspection report; running a geometric calibration mapping procedure to obtain a plot of optical distance versus pipeline distance; transforming a horizontal axis of the plot from optical distance to pipeline distance using an obtained function; and overlaying one or more fiber events and one or more historical events on the plot.

The non-transitory, computer readable medium of any proceeding clause, wherein contextualizing the fiber optic events is based on data from an inspection report, a simulation, a supervisory control and data acquisition (SCADA) system, a historical report, or any combination thereof.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving first data collected as a first pipeline inspection gauge (PIG) passes through a first pipeline;
training a machine learning model using the first data;
receiving second data collected via an optical fiber as a second PIG passes through a second pipeline, wherein the second data is representative of one or more fiber optic events;
applying the trained machine learning model to the second data;
identifying a position of the second PIG; and
generating a graphical user interface (GUI) to display the position of the second PIG.

2. The method of claim 1, wherein the first data comprises a waterfall image, and wherein training the machine learning model comprises:
splitting the waterfall image into a plurality of sub-images, each comprising a V-shaped plot;
generating a plurality of respective training images based on the sub-images, wherein each training image of the plurality of respective training images comprises a bounding box (bbox) centered on the V-shaped plot; and
providing the training images to the machine learning model during a training cycle.

3. The method of claim 2, wherein each of the sub-images comprises a plot of the first data over a time interval.

4. The method of claim 2, wherein first and second corners of each respective bbox intersects with the V-shaped plot, and wherein a lower midpoint of an edge of each respective bbox, opposite the first and second corners, corresponds to a location of the second PIG.

5. The method of claim 2, wherein each bbox has a fixed width.

6. The method of claim 2, wherein training the machine learning model comprises determining a respective confidence level of detection for each bbox.

7. The method of claim 4, comprising:
requesting a down-sampled snapshot of the waterfall image from a fiber system data server;
providing the down-sampled snapshot to the machine learning model to extract V-shape intersections;
setting the lower midpoint of each bbox;
removing outliers that are determined not to correspond to PIG runs;
running a monotonic piecewise polygon fitting algorithm to generate a trajectory of the second PIG;
estimating a velocity of the second PIG; and
determining an estimated time of arrival (ETA) of the second PIG to a location along the second pipeline.

8. The method of claim 7, wherein removing outliers comprises using filter by confidence level, clustering, derivative control, or any combination thereof.

9. A system, comprising:
processing circuitry; and
a memory, accessible by the processing circuitry, and storing instructions that, when executed by the processing circuitry, cause the processing circuitry to perform operations comprising:
receiving first data collected as a first pipeline inspection gauge (PIG) passes through a first pipeline;
training a machine learning model using the first data;
receiving second data collected via an optical fiber as a second PIG passes through a second pipeline, wherein the second data is representative of one or more fiber optic events;
applying the trained machine learning model to the second data;
identifying a position of the second PIG;
generating a graphical user interface (GUI) to display the position of the second PIG; and automatically calibrating a distance along the optical fiber to distance along the second pipeline.

10. The system of claim 9, wherein the first data comprises a waterfall image, and wherein training the machine learning model comprises:
splitting the waterfall image into a plurality of sub-images, each comprising a V-shaped plot;
generating a plurality of respective training images based on the sub-images, wherein each training image of the plurality of respective training images comprises a bounding box (bbox) centered on the V-shape plot; and
providing the training images to the machine learning model during a training cycle.

11. The system of claim 10, comprising:
requesting a down-sampled snapshot of the waterfall image from a fiber system data server;
providing the down-sampled snapshot to the machine learning model to extract V-shapes;
setting a lower midpoint of each bbox;
removing outliers that are determined not to correspond to PIG runs;
running a monotonic piecewise polygon fitting algorithm to generate a trajectory of the second PIG;
estimating a velocity of the second PIG; and
determining an estimated time of arrival (ETA) of the second PIG to a location along the second pipeline.

12. The system of claim 11, wherein automatically calibrating the distance along the optical fiber to distance along the second pipeline comprises:
extracting the trajectory of the second PIG from the waterfall image;
extracting longitude and latitude of the trajectory of the second PIG from an inspection report;
running a geometric calibration mapping procedure to obtain a plot of optical distance versus pipeline distance;
transforming a horizontal axis of the plot from optical distance to pipeline distance using an obtained function; and
overlaying one or more fiber events and one or more historical events on the plot.

13. The system of claim 12, wherein transforming the horizontal axis of the plot reduces a width of the waterfall image.

14. The system of claim 12, wherein automatically calibrating the distance along the optical fiber to the distance along the second pipeline comprises applying a software-based interactive fine-tuning system.

15. The system of claim 14, wherein applying the software-based interactive fine-tuning system comprises examining inspection events overlayed on an image.

16. A non-transitory, computer readable medium comprising instructions that, when executed by a processing circuitry, cause the processing circuitry to perform operations comprising:
receiving first data collected as a first pipeline inspection gauge (PIG) passes through a first pipeline;
training a machine learning model using the first data;
receiving second data collected via an optical fiber as a second PIG passes through a second pipeline, wherein the second data is representative of one or more fiber optic events;
applying the trained machine learning model to the second data;
identifying a position of the second PIG;
generating a graphical user interface (GUI) to display the position of the second PIG; automatically calibrating a distance along the optical fiber to distance along the second pipeline; and
overlaying the second data with the GUI.

17. The non-transitory, computer readable medium of claim 16, wherein the first data comprises a waterfall image, and wherein training the machine learning model comprises:
splitting the waterfall image into a plurality of sub-images, each comprising a V-shaped plot;
generating a plurality of respective training images based on the sub-images, wherein each training image of the plurality of respective training images comprises a bounding box (bbox) centered on the V-shape plot; and
providing the training images to the machine learning model during a training cycle.

18. The non-transitory, computer readable medium of claim 17, comprising:
requesting a down-sampled snapshot of the waterfall image from a fiber system data server;
providing the down-sampled snapshot to the machine learning model to extract V-shapes;
setting a lower midpoint of each bbox;
removing outliers that are determined not to correspond to PIG runs;
running a monotonic piecewise polygon fitting algorithm to generate a trajectory of the second PIG;
estimating a velocity of the second PIG; and
determining an estimated time of arrival (ETA) of the second PIG to a location along the second pipeline.

19. The non-transitory, computer readable medium of claim 18, wherein automatically calibrating the distance along the optical fiber to distance along the second pipeline comprises:
extracting the trajectory of the second PIG from the waterfall image;
extracting longitude and latitude of the trajectory of the second PIG from an inspection report;
running a geometric calibration mapping procedure to obtain a plot of optical distance versus pipeline distance;
transforming a horizontal axis of the plot from optical distance to pipeline distance using an obtained function; and
overlaying one or more fiber events and one or more historical events on the plot.

20. The non-transitory, computer readable medium of claim 16, wherein contextualizing the fiber optic events is based on data from an inspection report, a simulation, a supervisory control and data acquisition (SCADA) system, a historical report, or any combination thereof.
